(19) United States
(12) Patent Application Publication
(10) Pub. No.: US 2014/0134411 A1
(43) Pub. Date: May 15, 2014

(54) LIGHT TRANSMITTIVE AlN PROTECTIVE LAYERS AND ASSOCIATED DEVICES AND METHODS

(71) Applicant: RITEDIA CORPORATION, Hsin Chu Industrial Park (TW)

(72) Inventor: Chien-Min Sung, Tansui (TW)

(73) Assignee: RiteDia Corporation, Hsin Chu Industrial Park (TW)

(21) Appl. No.: 13/678,517

(22) Filed: Nov. 15, 2012

(51) Int. Cl. C09D 1/00

(52) U.S. Cl. CPC C09D 1/00
USPC 428/212; 427/162

(57) ABSTRACT

Devices having light transmittant protective layers and methods associated with such layers are provided. In one aspect, for example, a device having a light transmittant protective layer can include a substrate having a transmittance of greater than or equal to about 85 for light having at least one wavelength from about 250 nm to about 800 nm, and a light transmittant protective layer coated on the substrate. The protective layer includes at least 50 wt % AlN and having a transmittance of greater than or equal to 80% for light having at least one wavelength from about 250 nm to about 800 nm.

### BACKGROUND OF THE INVENTION

Various surfaces that transmit light exhibit degraded efficiencies throughout the lifetime of the device to which they are associated. For example, DVDs, CDs, touch screens, glasses, and the like become scratched through normal use and thus, in some cases, will exhibit degraded performance and even complete failure due to such wear and tear. Numerous materials have been utilized in an attempt to provide protective layers for such devices. In many cases, such materials actually reduce the transmittance of light from the device, and thus have limited uses. In other cases, the protective material is softer than the underlying surface to be protected, and thus merely transfers the scratching problem to a different material layer.

### SUMMARY OF THE INVENTION

The present disclosure provides devices having light transmittant protective layers and methods associated with such layers. In one aspect, for example, a device having a light transmittant protective layer can include a substrate having a transmittance of greater than or equal to about 85% for light having at least one wavelength from about 250 nm to about 800 nm, and a light transmittant protective layer coated on the substrate. The protective layer can include at least 50 wt % AlN and having a transmittance of greater than or equal to 80% for light having at least one wavelength from about 250 nm to about 800 nm. In another aspect, the protective layer can include at least 75 wt % AlN. In yet another aspect, the protective layer has a transmittance of greater than or equal to 80% for light having at least one wavelength from about 400 nm to about 500 nm.

Additionally, in some aspects the protective layer can be hardened by any technique capable of hardening a layer containing AlN as a majority component. In one aspect, for example, the protective layer can be hardened by doping with a boron dopant. The amount of boron used can vary depending on the desired properties of the protective layer. In one aspect, however, the boron dopant is doped into the protective layer at a concentration of from about 5 atomic % to about 15 atomic %.

Furthermore, the protective layer can be formed as an electrically conductive layer. In one aspect, for example, the protective layer has an electrical resistivity of from about 1.0×10⁻⁴ to about 3.0×10⁻⁴ ohm cm. Various techniques can be utilized to increase the electrical conductivity of the protective layer, any of which are within the present scope. In one aspect, for example, the protective layer is doped with a dopant selected from the group consisting of gallium, indium, or a combination thereof. In one specific aspect, the dopant is doped into the protective layer at a total dopant concentration of from about 25 atomic % to about 90 atomic %.

The light transmittant protective layer can be applied to a variety of substrates. Non-limiting examples of suitable substrates include glass materials, polymeric materials, sapphire materials, quartz materials, cubic zirconia materials, and combinations thereof. In one specific aspect, the substrate is a polymeric material. In another specific aspect, the polymeric material is a polycarbonate.

In one specific aspect, the device is an optical storage media device. Any such storage media devices can be coated with the protective layers of the present disclosure, however in one aspect the optical storage media device is capable of storing from 4 GB of data to 10 GB of data. In another aspect, the media device may be capable of storing greater than 10 GB of data. In another aspect, the device is a touch screen.

The present disclosure additionally provides methods of protecting a light transmitting substrate of a device. In one aspect, for example, such a device can include depositing a light transmittant protective layer on the substrate, the protective layer including at least 50 wt % AlN and having a transmittance of greater than or equal to 80% for light having at least one wavelength from about 250 nm to about 800 nm, and wherein the substrate has a transmittance of greater than or equal to 85% for light having at least one wavelength from about 250 nm to about 800 nm. In one specific aspect, the method can include depositing the protective layer by PVD deposition. In another aspect, the method can include applying a protective layer precursor on the substrate by a screen printing process and heating the protective layer precursor to form the protective layer.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 shows a cross-sectional side view of an optical media device in accordance with one embodiment of the present invention.

FIG. 2 shows a cross-sectional side view of an optical media device in accordance with another embodiment of the present invention.

FIG. 3 shows a cross-sectional side view of a touch screen in accordance with yet another embodiment of the present invention.

The drawings will be described further in connection with the following detailed description. Further, these drawings are not necessarily to scale and are by way of illustration only such that dimensions and geometries can vary from those illustrated.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “the layer” includes one or more of such layers, reference to “an additive” includes reference to one or more of such materials, and reference to “a cathodic arc technique” includes reference to one or more of such techniques.

Definitions

In describing and claiming the present invention, the following terminology will be used in accordance with the definitions set forth below.

As used herein, “vapor deposited” refers to materials which are formed using vapor deposition techniques. “Vapor deposition” refers to a process of depositing materials on a substrate through the vapor phase. Vapor deposition processes can include any process such as, but not limited to, chemical vapor deposition (CVD) and physical vapor deposition (PVD). A wide variety of variations of each vapor deposition method can be performed by those skilled in the art. Examples of vapor deposition methods include hot filament CVD, rf-CVD, laser CVD (LCVD), laser ablation, conformal diamond coating processes, metal-organic CVD (MOCVD), sputtering, thermal evaporation PVD, ionized metal PVD (IMPVD), electron beam PVD (EBPVD), reactive PVD, atomic layer deposition (ALD), and the like.

As used herein, the term “substantially” refers to the complete or nearly complete extent or degree of an action, characteristic, property, state, structure, item, or result. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect on the property of interest thereof.

As used herein, the term “about” is used to provide flexibility to a numerical range endpoint by providing that a given value may be “a little above” or “a little below” the endpoint with a degree of flexibility as would be generally recognized by those skilled in the art. Further, the term about explicitly includes the exact endpoint, unless specifically stated otherwise.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The Invention

The present disclosure provides light transmittant protective layers, including devices incorporating such layers, and associated methods. Various surfaces that transmit light exhibit degraded efficiencies throughout the lifetime of the device to which they are associated. Such degraded efficiencies can be a result of many factors, non-limiting examples including scratching, accumulation of dirt, oil and other light-blocking or refractive substances, and the like. The present light transmittant protective layers can provide protection to such surfaces, either by coating thereover or replacing the surface altogether. Non-limiting examples of devices that can benefit from such light transmittant protective layers include LEDs, touch screens, optical storage media (including CD's and DVD'S), SAW filters, and the like.

It has now been discovered that a light transmittant protective layer can be made from AlN materials. Red light photons carry about 1.8 eV of energy, while blue light photons carry about 3.5 eV. AlN has a bandgap of about 6 eV, which is greater than the energy carried by light in the red to blue range. AlN materials are transparent, therefore, to light within this range. This light transparency allows AlN to be used as a protective coating over other light transmittant substrates, such as optical storage media, touch screens, eyeglasses, watch crystals, and the like. In some aspects, an AlN layer can be utilized as the light transmittant substrate rather than as merely a protective light transmittant layer that is applied over the substrate. For example, in one aspect an AlN layer can be used as a thin protective layer that is applied over a touch screen interface, and in another aspect an AlN layer can be used as the touch screen interface itself. Additionally, in one aspect and AlN layer can be used as a thin protective layer that is applied over a polycarbonate or other transparent for an optical storage media, and in other aspects, the AlN layer can be used by itself in place of the polycarbonate, or other transparent layer.

AlN materials can be abrasion resistant and chemically inert, and thus can be used to protect a device against abrasion, scratching, and chemical breakdown. In addition, doping can vary the physical properties of the MN materials in order to improve various properties for some applications. For example, AlN can be doped with B to increase the hardness and in some cases the transparency of the AlN layer. This can be useful for devices that are easily scratched or otherwise abraded, for device that exhibit decreased performance due to wear over time, or for situations where improved AlN layer hardness is desired. In another aspect, AlN can be doped with Ga, In, or the like in order to improve the electrical conductivity of the AlN material. Electrically conductive AlN layers can be used beneficially in a variety of applications. One example of such an application is as a protective layer for a touch screen.

In one aspect of the present disclosure, a device having a light transmittant protective layer is provided. Such a device can include a substrate having a transmittance of greater than or equal to about 85% for light having at least one wavelength from about 250 nm to about 800 nm, and a light transmittant protective layer coated on the substrate. The protective layer includes at least 50 wt % AlN and has a transmittance of greater than or equal to 80% for light having at least one wavelength from about 250 nm to about 800 nm. In another aspect, the protective layer includes at least 75 wt % AlN. In yet another aspect, the protective layer may include from about 35% AlN to about 80% AlN. Furthermore, in another aspect the protective layer has a transmittance of greater than or equal to 80% for light having at least one wavelength from about 400 nm to about 500 nm. In some aspects the transmittance of light have at least one wavelength in this range may be from about 55% to 90%. In other aspects the amount of transmittance may be from about 65% to about 85%. Additionally, in some cases the protective layer can have a thickness that is from about 10 nm to about 3 μm. In another aspect the thickness may be from about 5 nm to about 1 μm. In yet another aspect, the protective layer can have a thickness that is from about 50 nm to about 1 μm.

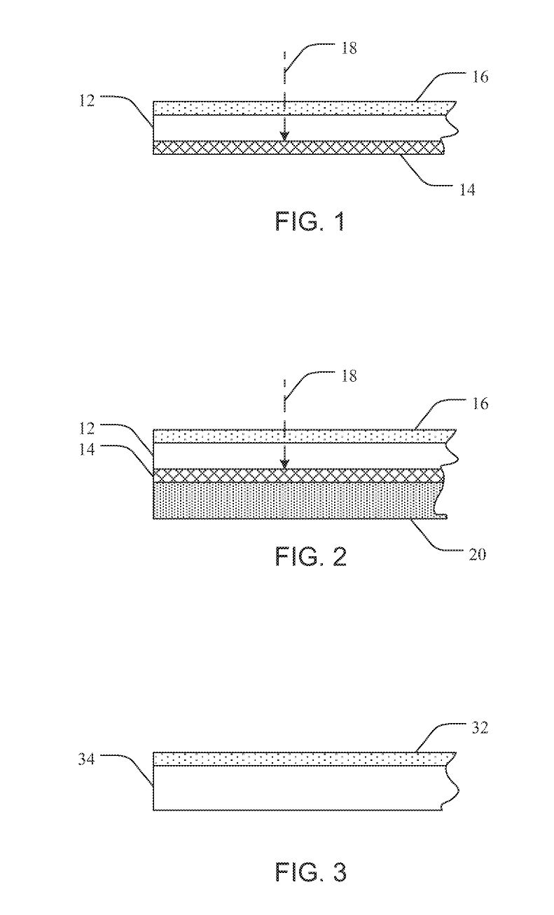

In one aspect of the present disclosure, a light transmittant protective layer can be applied to an optical storage media device. For example, FIG. 1 shows a light transmittant substrate 12 having an associated recording layer 14. A light transmittant protective layer 16 is applied to the substrate 12. In this case, light 18 from a reading device such as a laser impinges on the recording layer 14 after passing through the protective layer 16 and the substrate 12. The protective layer 16 can thus provide added protection to the substrate to increase the longevity of the optical storage media as well as reducing scratches and abrasions. The protective layer can include AlN, and in some cases the AlN can be B doped in order to increase the hardness and durability of the layer. The materials used in the substrates of optical storage media can vary, but are generally a polymeric substance such as polycarbonate. By coating the substrate with AlN, the added hardness will increase the scratch resistance of the optical storage media device. Additionally, the light transmittant properties of AlN allow the unimpeded access of the laser light through the substrate and onto the recording layer. This is particularly beneficial for optical storage media readers that utilize blue laser light, such as Blu-Ray disks, as AlN is particularly transparent to blue light wavelengths as compared to many other coating materials.

The structure of an optical storage media device can vary depending on the type of device and the system used for reading. As is shown in FIG. 2, for example, a light transmittant substrate 12 having an associated read and/or recording layer 14 and a light transmittant protective layer 16 is shown. As was shown in FIG. 1, light 18 from the reading device impinges on the recording layer 14 after passing through the protective layer 16 and the substrate 12. A support substrate 20 can be coupled to the recording layer 14 opposite the light transmittant substrate 12. This structural configuration is similar to CD, DVD, and HD-DVD or Blu-Ray disks.

Any type of optical storage media known can benefit from the AlN protective layers of the present disclosure. Non-limiting examples of such media include CDs, DVDs, Blu-Ray disks, rewritable optical storage media, and the like. In one aspect, the optical storage media device can be a DVD and/or a Blu-Ray disk. In another aspect, the optical storage media device is capable of storing greater than 10 GB of data on a single disk. In yet another aspect, the optical storage media device may be capable of storing from 500 MB to 500 GB. In one aspect, the amount of storage may be 780 MB. In another aspect, the amount may be 4 GB. In yet a further aspect, the amount may be 8 GB. In some aspects, the media read/recording layer may be dual density.

Regardless of the type of device, optical storage media can be protected through the application of a protective AlN layer over the surface through which the laser or optical reading source passes. Additionally, in some aspects the AlN layer can be applied directly to the recording layer, and thus replace the light transmittant substrate of many current optical storage media designs. This may be particularly beneficial for optical storage media such as Blu-Ray, where the light transmittant substrate is already very thin relative to the overall thickness of the disk.

In another aspect, light transmittant protective layers can be utilized to provide additional protection to touch screen devices. Various designs for touch screen devices are contemplated, and any such design is considered to be within the present scope. Non-limiting examples of touch screen technologies include resistive, capacitive, surface acoustic wave (SAW), infrared, optical imaging, acoustic pulse recognition, dispersive signal technology, and the like. Thus, regardless of the technology, a touch screen can be coated with a light transmittant protective layer to provided added protection to the device. Because the AlN material is transmittant to visible light, images displayed by the touch screen are readily transmitted through the AlN material and viewed by a user. As is shown in FIG. 3, for example, a light transmittant protective layer 32 that includes AlN material is disposed onto a touch screen 34. If the touch screen technology utilizes an electrical property change to sense screen touches, the AlN layer can be doped with a dopant such as Ga or In to increase the conductivity of the layer, thus allowing finger touches to be registered through the AlN layer. For example, one touch screen design based on capacitance change utilizes a grid of indium tin oxide (ITO) electrodes running in perpendicular directions. The perpendicular ITO electrodes are insulated from one another, and therefore can detect the capacitance changes of a finger touch. A conductive AlN layer can thus be applied to such a touch screen to provide protection to the device. The AlN layer can additionally be doped with B to increase the hardness of the layer, thereby increasing the durability of the device.

In another aspect, the AlN layer can be utilized in conjunction with a SAW-type touch screen. AlN materials exhibit a piezoelectric effect due, at least in part, to a hexagonal wurtzite crystal structure. The high shear modulus and low density of this material can support very high surface acoustic wave (SAW) frequencies. SAW touch screens generally include acoustic waves generated across the surface of the touch region of the screen. This can be accomplished via SAW emitters and receivers embedded around the periphery of the touch screen. Any object such as a finger that impinges on the screen is thus detected by the scattering of the acoustic waves over that surface. Thus, the wave pattern is analyzed and the location of the touch is determined relative to the edges of the screen.

As noted above, various dopants can enhance or control the hardness and/or the conductivity of the AlN layer. Any dopant that can be used to improve the AlN layer is considered to be within the present scope, including for example, B, Ga, In, conductive metals, and the like, including combinations thereof. In one specific aspect, the AlN layer is doped with a B dopant. The amount of B dopant in the AlN layer is contemplated to be that which is sufficient to provide the desired properties of the layer. In one aspect, for however, the B dopant is doped into the AlN layer at a concentration of from about 5 at % to about 15 at %. In another aspect, the B dopant is doped into the AlN layer at a concentration of from about 10 at % to about 15 at %. As a non-limiting example of B doping of AlN, an AlN:B target can be sputtered onto a substrate to form the protective AlN layer having increased hardness.

Additionally, it can be beneficial to inhibit water and/or oils from collecting on the surface of the AlN layer. In some aspects, the AlN layer can be doped with a dopant that can reduce the adherence of oils, such as for example, F or H doping. In another aspect, a material such as diamond-like carbon (DLC) can be applied to the AlN material to inhibit the actual touching of the AlN layer. Such a material can thus inhibit water and oil from collecting on the AlN surface. The DLC material can be applied as a pattern of micron or nano-sized dots, or as any other pattern, such as for example, a lined grid. In such cases, a methane-coated DLC material can be utilized to repel water from the layer surface. DLC can also be applied as a layer to the AlN layer. DLC normally poorly adheres to glass. AlN coated on SiO₂ glass can form SiAlON, a ceramic that has a good range of chemical compatibilities. This ceramic layer can thus promote the adherence of DLC to glass.

In another aspect, the AlN layer is doped with a Ga dopant. The amount of Ga dopant in the AlN layer is contemplated to be that which is sufficient to provide the desired properties of the layer. In one aspect, however, the Ga dopant is doped into the AlN layer at a concentration of from about 5 at % to about 90 at %. In another aspect the Ga dopant is doped into the AlN layer at a concentration of from about 25 at % to about 90 at %. In another aspect the Ga dopant is doped into the AlN layer at a concentration of from about 5 at % to about 50 at %. Doping can occur during or following the formation of the AlN layer. Such doping techniques would be readily understood by one of ordinary skill in the art once in possession of the present disclosure. Furthermore, the degree of electrical conductivity of the AlN layer can vary depending on the desired properties and uses of the layer, and any degree of electrical conductivity is considered to be within the present scope. In one aspect, however, the AlN layer has an electrical resistivity of from about 1.0×10⁻⁴ to about 3.0×10⁻⁴ ohm cm. In another aspect, the AlN layer has an electrical resistivity of from about 1.0×10⁻⁴ to about 2.5×10⁻⁴ ohm cm. In yet another aspect, the AlN layer has an electrical resistivity of from about 1.0×10⁻⁴ to about 2.0×10⁻⁴ ohm cm. Furthermore, in some aspects similar results can be achieved by doping with other dopants such as In. As a non-limiting example of Ga doping of AlN, an AlN:Ga target can be made by forming an alloy of AlGa and sputtering in a nitrogen atmosphere.

One issue that can arise with the sputtering of AlN from an AlN target is the overabundance of Al atoms in the target. A high excess Al concentration in the AlN layer can inhibit light transmittance and increase the hydrophilicity of the AlN layer. Free Al can be reduced or eliminated in the forming layer by sputtering in an atmosphere containing N. The N will be incorporated into the layer with Al, thus forming AlN. A greater N atomic % can also be incorporated into the target to reduce the free Al in the resulting AlN layer.

Numerous substrates upon which the AlN layer is deposited are contemplated, and these substrates include light transmittant substrates and non-light transmittant substrates. In those aspects where the AlN layer is applied to a light transmittant substrate, any substrate material capable of transmitting light and receiving a protective AlN layer deposited thereon would be considered to be within the present scope. Non-limiting examples include glass materials, polymeric materials, semiconductor materials, and the like, including combinations thereof. In one aspect, the light transmitting substrate can be a polymeric material. In one specific aspect, the polymeric material can be a polycarbonate. In those aspects where the AlN layer is deposited onto a substrate as a replacement for a light transmittant substrate, any substrate material capable of receiving a protective AlN layer deposited thereon is considered to be within the present scope. Non-limiting examples include metal materials, ceramic materials, semiconductor materials, polymeric materials, and the like, including combinations thereof.

The protective and light transmittant AlN layers of the present disclosure can be deposited on a substrate by any technique capable of depositing AlN material in a manner that results in a layer having light transmittant properties. In one aspect, for example, the AlN material can be deposited by a vapor deposition process. Such vapor deposition processes can include chemical vapor deposition (CVD) and physical vapor deposition (PVD) techniques. In one specific example, the AlN protective layer can be deposited by a PVD process. Non-limiting examples of suitable processes include vapor deposition, cathodic arc deposition, ion bombardment, RF coupling, electron beam PVD, evaporative deposition, pulsed laser deposition, sputtering, magnetron sputtering, and the like. In one specific aspect, the PVD deposition can be by sputtering. Sputtering is capable of depositing AlN layers onto a variety of substrate materials at a lower cost than CVD deposition techniques.

Additionally, in another aspect, an AlN layer can be formed by depositing AlN material on a substrate and hardening the layer into a protective AlN layer. For example, in one aspect and AlN material can be deposited onto a substrate to form a protective layer precursor by a process such as screen printing, ink jet printing, spraying, and the like. The protective layer precursor can then be heated to form a protective layer of the AlN material.

The AlN layer can be deposited onto an entire surface of a substrate or only a portion thereof, depending on the desired configuration of the protective layer. Additionally, AlN layers can have various thicknesses. In some aspects, only very thin layers may be adequate to achieve a desired result, where other aspects utilize relatively thick layers. As such, the present scope is not limited by AlN layer thickness. That being said, in one aspect the AlN layer can have a thickness of from about 100 μm to about 1 mm. In another aspect, the AlN layer can have a thickness of from about 10 μm to about 100 μm. In yet another aspect, the AlN layer can have a thickness of from about 100 nm to about 10 μm. In a further aspect, the AlN layer can have a thickness of from about 10 nm to about 1 μm. In yet a further aspect, the AlN layer can have a thickness of from about 10 nm to about 30 nm. In some aspects, the AlN layer can have a thickness of from about 1 nm to about 100 nm. It should be noted that, in some cases, the transmittance of PVD AlN layers is facilitated for thicknesses of less than about 100 nm.

The present disclosure additionally provides methods of protecting a light transmitting substrate of a device. In one aspect, one such method can include depositing a light transmittant protective layer on a light transmitting substrate, where the protective layer includes at least 50 wt % AlN and has a transmittance of greater than or equal to 80% for light having at least one wavelength from about 250 nm to about 800 nm. Additionally, the substrate has a transmittance of greater than or equal to 85% for light having at least one wavelength from about 250 nm to about 800 nm.

The following are examples illustrate various methods of making electronic devices in accordance with the present invention. However, it is to be understood that the following are only exemplary or illustrative of the application of the principles of the present invention. Numerous modifications and alternative compositions, methods, and systems can be devised by those skilled in the art without departing from the spirit and scope of the present invention. The appended claims are intended to cover such modifications and arrangements. Thus, while the present invention has been described above with particularity, the following Examples provide further detail in connection with several specific embodiments of the invention.

### EXAMPLE 1

A glass panel is coated with an AlN layer and doped such that 10% of Al atoms are replaced with B atoms. The four edges of the AlN layer are coated (e.g. sputter or vapor deposition) with dots of Al that are connected to electrodes. Two are connected to emitters and the other two to receivers. Opposite edges are dotted with emitters on one side and receivers on the other. When a voltage is applied to the emitter, a surface acoustic wave (SAW) is generated that moves to the opposite side of AlN layer where the receivers reside. If a touch point is not present, the waves will move in parallel. But if a touch point is present, the SAWs are scattered. The receivers can thus detect the perturbations of the SAWs at various locations along the AlN layer periphery. These perturbations can be interpreted by an IC processor to determine the locations and sizes of the touched points, the pressure distribution of each touch, and movements of individual point where touching has occurred.

### EXAMPLE 2

A polycarbonate substrate overlaying an optically readable and/or recordable layer is provided. AlN layer is coated onto the polycarbonate substrate via deposition to a substantially uniform thickness of less than about 100 nm. The AlN and polycarbonate layers provide a blue light laser transmissivity of over 90%.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A device having a light transmittant protective layer, comprising:
a substrate having a transmittance of greater than or equal to about 90% for light having at least one wavelength from about 250 nm to about 800 nm; and
a light transmittant protective layer coated on the substrate, the protective layer including at least 50 wt % AlN and having a transmittance of greater than or equal to 80% for light having at least one wavelength from about 250 nm to about 800 nm.

2. The device of claim 1, wherein the protective layer includes at least 75 wt % AlN.

3. The device of claim 1, wherein the protective layer has a transmittance of greater than or equal to 80% for light having at least one wavelength from about 400 nm to about 500 nm.

4. The device of claim 1, wherein the protective layer is doped with a boron dopant.

5. The device of claim 4, wherein the boron dopant is doped into the protective layer at a concentration of from about 5 at % to about 15 at %.

6. The device of claim 1, wherein the substrate includes a member selected from the group consisting of glass materials, polymeric materials, sapphire materials, quartz materials, cubic zirconia materials, and combinations thereof.

7. The device of claim 1, wherein the substrate is a polymeric material.

8. The device of claim 7, wherein the polymeric material is a polycarbonate.

9. The device of claim 7, wherein the device is an optical storage media device.

10. The device of claim 9, wherein the optical storage media device is capable of storing greater than 10 GB of data.

11. The device of claim 1, wherein the protective layer has an electrical resistivity of from about 1.0×10⁻⁴ to about 3.0×10⁻⁴ ohm cm.

12. The device of claim 11, wherein the protective layer is doped with a dopant selected from the group consisting of gallium, indium, or a combination thereof.

13. The device of claim 12, wherein the dopant is doped into the protective layer at a total dopant concentration of from about 25 at % to about 90 at %.

14. The device of claim 11, wherein the device is a touch screen.

15. A method of protecting a light transmitting substrate of a device, comprising:
depositing a light transmittant protective layer on a light transmitting substrate, the protective layer including at least 50 wt % AlN and having a transmittance of greater than or equal to 80% for light having at least one wavelength from about 250 nm to about 800 nm, wherein the substrate has a transmittance of greater than or equal to 85% for light having at least one wavelength from about 250 nm to about 800 nm.

16. The method of claim 15, wherein depositing the protective layer is by PVD deposition.

17. The method of claim 15, wherein depositing the protective layer further includes:
applying a protective layer precursor on the substrate by a screen printing process; and
heating the protective layer precursor to form the protective layer.

18. The method of claim 15, further comprising increasing hardness of the protective layer by doping with boron.

19. The method of claim 15, further comprising increasing the conductivity of the protective layer by doping with a dopant selected from the group consisting of gallium, indium, or a combination thereof.

20. The method of claim 15, further comprising increasing the conductivity of the protective layer by doping with gallium.
